(19) United States
(12) Patent Application Publication
(10) Pub. No.: US 2025/0227314 A1
(43) Pub. Date: Jul. 10, 2025

(54) Enhanced Signalling of Lost Or Corrupted Samples In a Media File

(71) Applicant: Bytedance Inc., Los Angeles, CA (US)

(72) Inventor: Ye-kui Wang, San Diego, CA (US)

(21) Appl. No.: 19/090,816

(22) Filed: Mar. 26, 2025

Related U.S. Application Data
(63) Continuation of application No. PCT/US2023/033624, filed on Sep. 25, 2023.
(60) Provisional application No. 63/410,509, filed on Sep. 27, 2022.
(60) Provisional application No. 63/413,551, filed on Oct. 5, 2022.

(51) Int. Cl. H04N 19/89; H04N 19/169; H04N 19/70

(52) U.S. Cl. CPC H04N 19/89; H04N 19/188; H04N 19/70

(57) ABSTRACT

A mechanism for processing media data is disclosed. The mechanism includes determining one or more indications for a media unit. A first indication indicates that one or more parameter-set-like network abstraction layer (NAL) units in associated data that are needed for decoding a bitstream are corrupted. A conversion is performed between media data and a media data file based on the first indication.

### CROSS-REFERENCE TO RELATED PATENT APPLICATIONS

This is a continuation of International Patent Application No. PCT/US2023/033624, filed on Sep. 25, 2023, which claims the benefit of U.S. Provisional Patent Application No. 63/410,509, filed Sep. 27, 2022, and U.S. Provisional Patent Application No. 63/413,551, filed Oct. 5, 2022, the teachings and disclosure of which are hereby incorporated in their entireties by reference thereto.

### TECHNICAL FIELD

The present disclosure relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing video data comprising: determining one or more indications for a media unit, wherein a first indication indicates that one or more parameter-set-like network abstraction layer (NAL) units in associated data that are needed for decoding a bitstream are corrupted; and performing a conversion between a visual media data and a visual media data file based on the first indication.

A second aspect relates to an apparatus for processing video data comprising: a processor; and a non-transitory memory with instructions thereon, wherein the instructions upon execution by the processor, cause the processor to perform any of the preceding aspects.

A third aspect relates to non-transitory computer readable medium comprising a computer program product for use by a video coding device, the computer program product comprising computer executable instructions stored on the non-transitory computer readable medium such that when executed by a processor cause the video coding device to perform the method of any of the preceding aspects.

A fourth aspect relates to a non-transitory computer-readable recording medium storing a bitstream of a video which is generated by a method performed by a video processing apparatus, wherein the method comprises: determining one or more indications for a media unit, wherein a first indication indicates that one or more parameter-set-like network abstraction layer (NAL) units in associated data that are needed for decoding a bitstream are corrupted; and generating a bitstream based on the determining.

A fifth aspect relates to a method for storing bitstream of a video comprising: determining one or more indications for a media unit, wherein a first indication indicates that one or more parameter-set-like network abstraction layer (NAL) units in associated data that are needed for decoding a bitstream are corrupted; generating a bitstream based on the determining; and storing the bitstream in a non-transitory computer-readable recording medium.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram showing an example video processing system.

FIG. 2 is a block diagram of an example video processing apparatus.

FIG. 3 is a flowchart for an example method of video processing.

FIG. 4 is a block diagram that illustrates an example video coding system.

FIG. 5 is a block diagram that illustrates an example encoder.

FIG. 6 is a block diagram that illustrates an example decoder.

FIG. 7 is a schematic diagram of an example encoder.

FIG. 8 is a flowchart for an example method of video processing.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

Section headings are used in the present disclosure for ease of understanding and do not limit the applicability of techniques and embodiments disclosed in each section only to that section. Furthermore, H.266 terminology is used in some description only for ease of understanding and not for limiting scope of the disclosed embodiments. As such, the embodiments described herein are applicable to other video codec protocols and designs also. In the present disclosure, editing changes are shown to text by bold italics indicating cancelled text and bold indicating added text, with respect to the Versatile Video Coding (VVC) specification and/or the International Organization for Standardization (ISO) base media file format (ISOBMFF) standard.

### 1. INITIAL DISCUSSION

This disclosure is related to media file format. Specifically, this disclosure is related to signalling of lost or corrupted samples in a media file. The examples may be applied individually or in various combinations, for media file formats, e.g., based on the ISOBMFF or its extensions, e.g., carriage of network abstraction layer (NAL) unit structured video in the ISOBMFF.

### 2. ABBREVIATIONS

The following abbreviations are used herein: adaptive color transform (ACT), adaptive loop filter (ALF), adaptive motion vector resolution (AMVR), adaptation parameter set (APS), access unit (AU), access unit delimiter (AUD), advanced video coding as described in Rec. ITU-T H.264|ISO/IEC 14496-10 (AVC), bi-predictive (B), bi-prediction with CU-level weights (BCW), bi-directional optical flow (BDOF), block-based delta pulse code modulation (BDPCM), buffering period (BP), context-based adaptive binary arithmetic coding (CABAC), coding block (CB), constant bit rate (CBR), cross-component adaptive loop filter (CCALF), coded picture buffer (CPB), clean random access (CRA), cyclic redundancy check (CRC), coding tree block (CTB), coding tree unit (CTU), coding unit (CU), coded video sequence (CVS), decoded picture buffer (DPB), decoding capability information (DCI), dependent random access point (DRAP), decoding unit (DU), decoding unit information (DUI), exponential-Golomb (EG), k-th order exponential-Golomb (EGk), end of bitstream (EOB), end of sequence (EOS), filler data (FD), first-in, first-out (FIFO), fixed-length (FL), green, blue, and red (GBR), general constraints information (GCI), gradual decoding refresh (GDR), geometric partitioning mode (GPM), high efficiency video coding as described in Rec. ITU-T H.265|ISO/IEC 23008-2 (HEVC), hypothetical reference decoder (HRD), hypothetical stream scheduler (HSS), intra (I), intra block copy (IBC), instantaneous decoding refresh (IDR), inter-layer reference picture (ILRP), intra random access point (IRAP), low frequency non-separable transform (LFNST), least probable symbol (LPS), least significant bit (LSB), long-term reference picture (LTRP), luma mapping with chroma scaling (LMCS), matrix-based intra prediction (MIP), most probable symbol (MPS), most significant bit (MSB), multiple transform selection (MTS), motion vector prediction (MVP), network abstraction layer (NAL), output layer set (OLS), operation point (OP), operating point information (OPI), predictive (P), picture header (PH), picture order count (POC), picture parameter set (PPS), prediction refinement with optical flow (PROF), picture timing (PT), picture unit (PU), quantization parameter (QP), random access decodable leading (RADL) picture, random access skipped leading (RASL) picture, raw byte sequence payload (RBSP), red, green, and blue (RGB), reference picture list (RPL), sample adaptive offset (SAO), sample aspect ratio (SAR), supplemental enhancement information (SEI), slice header (SH), subpicture level information (SLI), string of data bits (SODB), sequence parameter set (SPS), short-term reference picture (STRP), step-wise temporal sublayer access (STSA), truncated rice (TR), variable bit rate (VBR), video coding layer (VCL), video parameter set (VPS), versatile supplemental enhancement information as described in Rec. ITU-T H.274|ISO/IEC 23002-7 (VSEI), video usability information (VUI), versatile video coding as described in Rec. ITU-T H.266|ISO/IEC 23090-3 (VVC).

### 3. FURTHER DISCUSSION

### 3.1 Video Coding Standards

Video coding standards have evolved primarily through the development of International Telecommunication Union (ITU) telecommunication standardization sector (ITU-T) and International Organization for Standardization (ISO)/International Electrotechnical Commission (IEC) standards. The ITU-T produced H.261 and H.263, ISO/IEC produced motion picture experts group (MPEG)-1 and MPEG-4 Visual, and the two organizations jointly produced the H.262/MPEG-2 Video and H.264/MPEG-4 Advanced Video Coding (AVC) and H.265/high efficiency video coding (HEVC) [1] standards. Since H.262, the video coding standards are based on the hybrid video coding structure wherein temporal prediction plus transform coding are utilized. Recently, the Versatile Video Coding (VVC) standard (ITU-T H.266|ISO/IEC 23090-3) [3] and the associated Versatile Supplemental Enhancement Information (VSEI) standard (ITU-T H.274|ISO/IEC 23002-7) [4] have been designed for use in a maximally broad range of applications, including both the traditional uses such as television broadcast, video conferencing, or playback from storage media, and also newer and more advanced use cases such as adaptive bit rate streaming, video region extraction, composition and merging of content from multiple coded video bitstreams, multiview video, scalable layered coding, and viewport-adaptive 360° immersive media. The Essential Video Coding (EVC) standard (ISO/IEC 23094-1) is another video coding standard that has recently been developed by MPEG.

### 3.2 File Format Standards

Media streaming applications are typically based on the internet protocol (IP), Transmission Control Protocol (TCP), and hypertext transfer protocol (HTTP) transport methods, and typically rely on a file format such as the ISOBMFF [5]. One such streaming system is dynamic adaptive streaming over HTTP (DASH) [6]. For using a video format with ISOBMFF and DASH, a file format specification specific to the video format, also referred to as network abstraction layer file format (NALFF) [7], which includes the file format specifications for all NAL units based video codecs such as AVC, HEVC, VVC, and their extensions, would be needed for encapsulation of the video content in ISOBMFF tracks and in DASH representations and segments. Important information about the video bitstreams, e.g., the profile, tier, and level, and many others, would need to be exposed as file format level metadata and/or DASH media presentation description (MPD) for content selection purposes, e.g., for selection of appropriate media segments both for initialization at the beginning of a streaming session and for stream adaptation during the streaming session. Similarly, for using an image format with ISOBMFF, a file format specification specific to the image format, such as the AVC image file format and the HEVC image file format in [8], would be needed.

### 3.3 Parameter Sets

AVC, HEVC, and VVC specify parameter sets. The types of parameter sets include SPS, PPS, APS, and VPS. SPS and PPS are supported in all of AVC, HEVC, and VVC. VPS is introduced in HEVC and is included in both HEVC and VVC. APS was not included in AVC or HEVC but is included in VVC.

SPS is designed to carry sequence-level header information, and PPS is designed to carry infrequently changing picture-level header information. With SPS and PPS, infrequently changing information need not to be repeated for each sequence or picture, hence redundant signalling of this information can be avoided. Furthermore, the use of SPS and PPS enables out-of-band transmission of the important header information, thus not only avoiding the need for redundant transmissions but also improving error resilience.

VPS is introduced for carrying sequence-level header information that is common for all layers in multi-layer bitstreams.

APS is introduced for carrying such picture-level or slice-level information that needs quite some bits to code, can be shared by multiple pictures, and in a sequence there can be quite many different variations.

### 3.4 APS, PH, DCI and OPI NAL Units in VVC

Some additional types of NAL units are introduced into VVC, including APS, PH, DCI, and OPI NAL units.

### 3.4.1 Adaptation Parameter Set (APS)

Adaptation parameter set (APS) conveys picture- and/or slice-level information that may be shared by multiple slices of a picture, and/or by slices of different pictures, but can change frequently across pictures and the total number of variants can be high thus not suitable for inclusion into the PPS. Three types of parameters are included in APSs: adaptive loop filter (ALF) parameters, luma mapping with chroma scaling (LMCS) parameters, and scaling list parameters. APSs can be carried in two distinct NAL unit types either preceding or succeeding the associated slices as a prefix or suffix. The latter can help in ultralow-delay scenarios, e.g., allowing an encoder to send the slices of a picture before generating ALF parameters, based on the picture, that are to be used by subsequent pictures in decoding order.

### 3.4.2 Picture Header (PH)

A picture header (PH) structure is present for each PU. A PH is present either in a separate PH NAL unit or included in the slice header (SH). The PH can only be included in the SH if the PU consists of only one slice. To simplify the design, within a Coded Layer Video Sequence (CLVS), PHs can only be either all in PH NAL units or all in SHs. When the PHs are in the SHs, there is no PH NAL unit in the CLVS.

PH is designed for two objectives. First, to help reduce signaling overhead of SHs for pictures containing multiple slices per picture, by carrying all parameters that have the same value for all slices of a picture, thus not repeating the same parameters in each SH. These include IRAP/GDR picture indications, inter/intra slices allowed flags, and information related to POC, RPL, deblocking filter, SAO, ALF, LMCS, scaling lists, QP delta, weighted prediction, coding block partitioning, virtual boundaries, the collocated picture, etc. Second, to help the decoder to identify the first slice of each coded picture containing multiple slices. Since one and only one PH is present for each PU, thus when the decoder receives a PH NAL unit, it easily knows that the next VCL NAL unit is the first slice of a picture.

### 3.4.3 Decoding Capability Information (DCI)

The DCI NAL unit contains bitstream-level Profile Tier Level (PTL) information. The DCI NAL unit includes one or more PTL syntax structures that can be used during session negotiation between sender and receiver of a VVC bitstream. When the DCI NAL unit is present in a VVC bitstream, each output layer set (OLS) in the CVSs of the bitstream shall conform to the PTL information carried in least one of the PTL structures in the DCI NAL unit.

In AVC and HEVC, the PTL information for session negotiation is available in the SPS (for HEVC and AVC) and in the VPS (for HEVC layered extension). This design of conveying the PTL information for session negotiation in HEVC and AVC has disadvantages because the scope of SPS and VPS is within a CVS, instead of the whole bitstream. Because of that, sender-receiver session initiation may suffer from re-initiation during bitstream streaming at every new CVS. DCI solves this problem since it carries bitstream-level information, thus, the compliance to the indicated decoding capability can be guaranteed until the end of the bitstream.

### 3.4.4 Operating Point Information (OPI)

The decoding processes of HEVC and VVC have similar input variables to set the decoding operating point, e.g., the target OLS and the highest sublayer of the bitstream to be decoded, through a decoder Application Programming Interface (API). However, in scenarios where layers and/or sublayers of the bitstream are removed during transmission or a device does not expose the decoder API to the application, it could occur that a decoder cannot be correctly informed about the operating point for decoder to process the given bitstream. Hence, the decoder may not be able to conclude on the properties of pictures in the bitstream, e.g., proper buffer allocation for decoded pictures as well as whether individual pictures are output or not. In order to address this issue, VVC adds a mode of indicating these two variables within the bitstream through the newly introduced operating point information (OPI) NAL unit. In the AUs at the beginning of the bitstream and its individual CVSs, the OPI NAL unit informs the decoder about the target OLS and the highest sublayer of the bitstream to be decoded.

In the case when the OPI NAL unit is present and the operating point is also provided to the decoder via decoder API information (e.g., the application may have more updated information about the target OLS and sublayer), the decoder API information takes precedence. In absence of both a decoder API and any OPI NAL unit in the bitstream, suitable fallback choices are specified in VVC to allow proper decoder operation.

### 3.5 VUI and SEI Messages

VUI is a syntax structure sent as part of the SPS (and possibly also in VPS in HEVC). VUI carries information that does not affect the normative decoding process, but that can be important for proper rendering of the coded video.

SEI assists in processes related to decoding, display or other purposes. Same as VUI, SEI does not affect the normative decoding process, either. SEI is carried in SEI messages. Decoder support of SEI messages is optional. However, SEI messages do affect bitstream conformance (e.g., if the syntax of an SEI message in a bitstream does not follow the specification, then the bitstream is not conforming) and some SEI messages are needed in the HRD specification.

The VUI syntax structure and most SEI messages used with VVC are not specified in the VVC specification, but rather in the VSEI specification. The SEI messages necessary for HRD conformance testing are specified in the VVC specification. VVC v1 defines five SEI messages relevant for HRD conformance testing and VSEI v1 specifies 20 additional SEI messages. The SEI messages carried in the VSEI specification do not directly impact conforming decoder behavior and have been defined so that they can be used in a coding-format-agnostic manner, allowing VSEI to be used in the future with other video coding standards in addition to VVC. Rather than referring specifically to VVC syntax element names, the VSEI specification refers to variables, whose values are set within the VVC specification.

Compared to HEVC, the VUI syntax structure of VVC focuses only on information relevant for proper rendering of the pictures and does not contain any timing information or bitstream restriction indications. In VVC, the VUI is signaled within the SPS, which includes a length field before the VUI syntax structure to signal the length of the VUI payload in bytes. This makes it possible for a decoder to easily jump over the information, and more importantly, allows convenient future VUI syntax extensions by directly adding new syntax elements to the end of the VUI syntax structure, in a similar manner as SEI message syntax extension.

The VUI syntax structure contains the following information:
The content being interlaced or progressive;
Whether the content contains frame-packed stereoscopic video or projected omnidirectional video;
Sample aspect ratio;
Whether the content is appropriate for overscan display;
Color description, including color primaries, matrix and transfer characteristics, which is particularly important to be able to signal ultra high definition (UHD) vs high definition (HD) color space as well as high dynamic range (HDR); and
Chroma location compared to luma (for which the signaling was clarified for progressive content compared to HEVC).

When the SPS does not contain any VUI, the information is considered unspecified and has to be conveyed via external means or specified by the application if the content of the bitstream is intended for rendering on a display.

Table 1 lists the SEI messages specified for VVC v1, as well as the specification containing their syntax and semantics. Of the 20 SEI messages specified in the VSEI specification, many were inherited from HEVC (for example, the filler payload and both user data SEI messages). Some SEI messages are essential for correct processing or rendering of the coded video content. This is for example the case for the mastering display color volume, the content light level information or the alternative transfer characteristics SEI messages which are particularly relevant for HDR content. Other examples include the equirectangular projection, sphere rotation, region-wise packing or omnidirectional viewport SEI messages, which are relevant for signaling and processing of 360° video content.

TABLE 1
List of SEI messages in VVC v1

| | |
|---|---|
| Name of SEI message | Purpose of SEI message |

SEI messages specified in the VVC specification

| | |
|---|---|
| Buffering period | Initial CPB removal delays for HRD |
| Picture timing | CPB removal delays and DPB output delays for HRD |
| Decoding unit information | CPB removal delays and DPB output delays for DU based |
| | HRD |
| Scalable nesting | Mechanism to associate SEI messages with specific output |
| | layer sets, layers or sets of subpictures |
| Subpicture level information | Information about levels for subpicture sequences |

SEI messages specified in the VSEI specification

| | |
|---|---|
| Filler payload | Filler data for adjusting the bit rate |
| User data registered by Rec. ITU-T T.35 | Convey user data, can be used as container for data by other |
| User data unregistered | organizations |
| Film grain characteristics | Model for film grain synthesis |
| Frame packing arrangement | Information about how stereoscopic video is coded in the |
| | bitstream, e.g., by packing the two pictures for each time |
| | instance of the two views into one picture |
| Parameter sets inclusion indication | Indication of whether the sequence contains all the required |
| | NAL units for decoding |
| Decoded picture hash | Hash of the decoded pictures for error detection |
| Mastering display color volume | Description of the color volume of a display used to author |
| | the content |
| Content light level information | Upper bounds for the nominal target brightness light level of |
| | the content |
| Dependent RAP indication | Indicates a picture using only the preceding IRAP picture for |
| | inter prediction referencing |
| Alternative transfer characteristics | Preferred alternative value for the transfer characteristics of |
| | the content |
| Ambient viewing environment | Characteristics of the nominal ambient viewing environment |
| | for the display of the content, can be used to assist the |
| | receiver in processing content depending on the local |
| | viewing environment |
| Content color volume | Color volume characteristics of the associated picture |
| Equirectangular projection | Indication of the projection format applied, including |
| Generalized cubemap projection | information needed for remapping of the content onto a |
| | sphere for rendering in omnidirectional video applications |
| Sphere rotation | Information on rotation angles for conversion between the |
| | global and local coordinate axes, for use in omnidirectional |
| | video applications |
| Region-wise packing | Information needed for remapping of the cropped decoded |
| | pictures, involving region-wise operations like |
| | repositioning, resizing and rotation, onto projected pictures, |
| | for use in omnidirectional video applications |
| Omnidirectional viewport | Coordinates of one or more regions corresponding to |
| | viewports recommended for display, for use in |
| | omnidirectional video applications |
| Frame-field information | Indicates how the associated picture should be displayed, its |
| | source scan, and whether it is a duplicate of a previous |
| | picture |
| Sample aspect ratio information | Information about sample aspect ratio of the associated |
| | picture |

SEI messages that are specified for VVC v1 include the frame-field information SEI message, the sample aspect ratio information SEI message, and the subpicture level information SEI message.

The frame-field information SEI message contains information to indicate how the associated picture should be displayed (such as field parity or frame repetition period), the source scan type of the associated picture and whether the associated picture is a duplicate of a previous picture. This information was be signaled in the picture timing SEI message in previous video coding standards, together with the timing information of the associated picture. However, it was observed that the frame-field information and timing information are two different kinds of information that are not necessarily signaled together. A typical example includes signaling the timing information at the systems level, but signaling the frame-field information within the bitstream. It was therefore decided to remove the frame-field information from the picture timing SEI message and signal it within a dedicated SEI message instead. This change also made it possible to modify the syntax of the frame-field information to convey additional and clearer instructions to the display, such as the pairing of fields together, or more values for frame repetition.

The sample-aspect ratio SEI message enables signaling different sample aspect ratios for different pictures within the same sequence, whereas the corresponding information contained in the VUI applies to the whole sequence. It may be relevant when using the reference picture resampling feature with scaling factors that cause different pictures of the same sequence to have different sample aspect ratios.

The subpicture level information SEI message provides information of levels for the subpicture sequences.

### 3.6 Signalling of Lost or Corrupted Samples in ISOBMFF

Section 1 of the ISOBMFF Technologies under Consideration document [9] includes a design for signalling of lost or corrupted samples using a sample group that is specified as follows:

```
class CorruptedSampleInfoEntry( )
extends SampleGroupDescriptionEntry (′corr′)
{
  bit(2) corrupted;
  bit(6) reserved;
  if (corrupted==2)
    bit(32) codec_specific_param;
}
```

corrupted indicates the corruption state of the associated data. Value 0 means that the entire data is lost, and the associated data size (sample size, or NAL size) shall be 0. Value 1 means that the data is corrupted without any additional information on the corruption. Value 2 means that the data is corrupted with codec specific information on the corruption. Value 3 is reserved.
codec_specific_param indicates codec specific information on the corruption. The coding format is the one of the sample associated to this sample group description.

Note: codec_specific_param information being dependent on the coding format, file writers may need to add and associate a different CorruptedSampleInfoEntry( ) entry with a sample each time the coding format is changing across samples.

If a data is not associated with a CorruptedSampleInfoEntry or if a data is associated with a description_group_index=0 by a sample group with the grouping_type ‘corr’, this means the data is not corrupted.

The processing of a sample with corrupted equal to 1 or 2 is context and implementation specific.

For NAL unit in ISOBMFF (NALUFF), state:

For NALU unit (NALU) based codecs, we propose the following semantics:

For NALU-based video formats, the codec_specific_param field of the CorruptedSampleInfoEntry is defined as a bit mask, with most significant bit first, of the following flags:
ParameterSetCorruptedFlag (value 0x00000001): indicates that one or more parameter sets (DCI, VPS, SPS, PPS, APS, OPI?) in the associated data is corrupted
SEICorruptedFlag (value 0x00000002): indicates that one or more SEI messages in the associated data is corrupted. SliceHeaderCorruptedFlag (value 0x00000004): indicates that one or more slice headers or picture headers in the associated data is corrupted
VCLCorruptedFlag (value 0x00000008): indicates that VCL data of one or more slices in the associated data is corrupted
OtherNon VCLNALCorruptedFlag (value 0x00000010): indicates that one or more NAL units in the associated data with types different from the above types is corrupted

A codec_specific_param with value 0 means no information is available for describing the corruption.

A CorruptedSampleInfoEntry may be used with a sample group of grouping_type ‘nalm’ and a NALUMapEntry, using the grouping_type_parameter ‘corr’. The groupID of the NALUMapEntry map entry indicates the index, starting from 1, in the sample group description of the CorruptedSampleInfoEntry. A groupID of 0 indicates that no entry is associated (the identified data is present and not corrupted).

### 4. TECHNICAL PROBLEMS ADDRESSED BY DISCLOSED EMBODIMENTS

In the following, the term parameter-set-like NAL units refer to parameter set NAL units, DCI NAL unit, and OPI NAL units collectively.

An example design for signalling of corruption in media data includes five cases as part of CorruptedSampleInfoEntry for NALFF: 1) corruption of parameter-set-like NAL units, 2) corruption of SEI messages; 3) corruption of slice headers or picture headers; 4) corruption of VCL data of one or more slices; and 5) corruption of other types of data. However, there are the following problems:

First, among the different types of the parameter-set-like NAL units, some of them affect the decoding of a bitstream, e.g., SPS and PPS, while others do not affect the decoding of a bitstream, e.g., DCI. It would be desirable to differentiate these in signaling the indication of corruption of parameter-set-like NAL units.

Second, SEI messages are contained in SEI NAL units, and each SEI NAL unit may contain or more SEI messages, and within an SEI NAL unit besides the contained SEI messages there is also some header-type of data in the SEI NAL unit. However, indication of corruption of the header-type of data in SEI NAL units is currently not covered.

Third, some SEI messages, e.g., the buffering period SEI message and the picture timing SEI message, affect bitstream conformance through the hypothetical reference decoder (HRD) operations, while other SEI messages do not affect HRD conformance. It would be desirable to differentiate these in signaling the indication of corruption of SEI messages.

Fourth, SEI messages can be categorized into essential ones and non-essential ones. The corruption of the former may lead to the video being unusable, while the corruption of the latter could often just be ignored. Therefore, it would be beneficial to differentiate the two in signaling the indication of corruption of SEI messages.

Fifth, for each VCL NAL unit, besides the slice header or picture header and the slice data, there is also the NAL unit header. However, indication of corruption of NAL unit headers is currently not covered.

Sixth, the term VCL data is unclear and needs to be clearly specified.

Seventh, in an example implementation, indication of the corruption of one or more of the reference pictures of the slices in a sample is missing.

Eighth, in an example implementation, indication of the corruption or loss of one or more of the parameter-set-like NAL units needed for decoding the slices in a sample is missing.

Ninth, in an example implementation, indication of the loss of some of the slices in a sample is not covered.

Tenth, in an example implementation, indication of the loss of some of the parameter-set-like NAL units in a sample is not covered.

### 5. A LISTING OF SOLUTIONS AND EMBODIMENTS

To address one or more of the above-described problems, methods as summarized below are disclosed. The aspects should be considered as examples to explain the general concepts and should not be interpreted in a narrow way. Furthermore, these examples can be applied individually or combined in any manner.

In the following, the term parameter-set-like NAL units refer to parameter set NAL units, DCI NAL unit, and OPI NAL units collectively. In the following, the media unit may refer to a set of samples belonging to one sample group, a sample, a subsample, a set of samples, or a set of subsamples.

### Example 1

To address drawbacks of the first problem, one or more of the following are signaled for a media unit.

An indication of one or more of the parameter-set-like NAL units in the media unit that are needed for decoding the bitstream being corrupted is signaled.

An indication of one or more of the parameter-set-like NAL units in the media unit that are not needed for decoding the bitstream being corrupted is signaled.

### Example 2

To address drawbacks of the problems two through four, one or more of the following are signaled for a media unit.

An indication of one or more SEI NAL units in the media unit that contain SEI messages affecting the HRD conformance being corrupted is signaled.

An indication of one or more SEI NAL units in the media unit that contain essential SEI messages not affecting HRD conformance being corrupted is signaled.

An indication of one or more SEI NAL units in the media unit that contain non-essential SEI messages not affecting HRD conformance being corrupted is signaled.

An indication of one or more SEI NAL units in the media unit that contain essential SEI messages being corrupted is signaled.

An indication of one or more SEI NAL units in the media unit that contain non-essential SEI messages being corrupted is signaled.

### Example 3

To address drawbacks of the fifth problem, one or more of the following are signaled for a media unit.

An indication of one or more NAL unit headers, slice headers, or picture headers in the media unit being corrupted is signaled.

An indication of one or more NAL unit headers in the media unit being corrupted is signaled.

An indication of one or more slice headers in the media unit being corrupted is signaled.

An indication of one or more picture headers in the media unit being corrupted is signaled.

### Example 4

To address drawbacks of the sixth problem, one or more of the following are signaled for a media unit.

An indication of VCL data of one or more slices in the media unit being corrupted is signaled, where VCL data refers to data in a VCL NAL unit excluding the NAL unit header, the slice header, and the picture header, if any.

### Example 5

To address drawbacks of problems seven through ten, one or more of the following are signaled for a media unit.

An indication of one or more of the reference pictures of the slices in the media unit being corrupted is signaled.

An indication of one or more of the parameter-set-like NAL units needed for decoding the slices in the media unit being corrupted is signaled.

An indication of the referenced data (motion or samples) of one or more of the reference pictures used by the slices in the media unit being corrupted is signaled.

An indication of one or more of the reference pictures of the slices in the media unit being corrupted or lost is signaled.

An indication of the referenced data (motion or samples) of one or more of the reference pictures used by the slices in the media unit being corrupted or lost is signaled.

An indication of one or more of the reference pictures of the slices in the media unit being lost is signaled.

An indication of the referenced data (motion or samples) of one or more of the reference pictures used by the slices in the media unit being lost is signaled.

An indication of one or more of the parameter-set-like NAL units needed for decoding the media unit being corrupted or lost is signaled.

An indication of one or more of the parameter-set-like NAL units needed for decoding the media unit being lost is signaled.

An indication of one or more of the slices in the media unit being lost is signaled.

An indication of one or more of the parameter-set-like NAL units in the media unit being lost is signaled.

An indication of one or more of the slices in the media unit being corrupted or lost is signaled.

An indication of one or more of the parameter-set-like NAL units in the media unit being corrupted or lost is signaled.

### 6. EMBODIMENTS

Below are some example embodiments for the aspects summarized in section 5. Most relevant parts that have been added or modified are shown in bold font, and some of the deleted parts are shown in italicized bold fonts. There may be some other changes that are editorial in nature and thus not highlighted.

### 6.1 First Embodiment

Below is the first embodiment, which is for examples 1, 2, 3, 4, and 5 summarized above. The shown text changes are relative to the design for handling of lost or corrupted samples using a sample group in [9].

```
class CorruptedSampleInfoEntry( )
extends SampleGroupDescriptionEntry (′corr′)
{
  bit(2) corrupted;
  bit(6) reserved;
  if (corrupted==2)
    bit(32) codec_specific_param;
}
```

corrupted indicates the corruption state of the associated data. Value 0 means that the entire data is lost, and the associated data size (sample size, or NAL size) shall be 0. Value 1 means that the data is corrupted without any additional information on the corruption. Value 2 means that the data is corrupted with codec specific information on the corruption. Value 3 is reserved.
codec_specific_param indicates codec specific information on the corruption. The coding format is the one of the sample associated to this sample group description.

Note: codec_specific_param information being dependent on the coding format, file writers may need to add and associate a different CorruptedSampleInfoEntry( ) entry with a sample each time the coding format is changing across samples.

If a data is not associated with a CorruptedSampleInfoEntry or if a data is associated with a description_group_index=0 by a sample group with the grouping_type ‘corr’, this means the data is not corrupted.

The processing of a sample with corrupted equal to 1 or 2 is context and implementation specific.

For NALUFF, state:

For NALU based codecs, we propose the following semantics:

In the following, the term parameter-set-like NAL units refer to parameter set NAL units, DCI

NAL unit, and OPI NAL units collectively.

For NALU-based video formats, the codec_specific_param field of the CorruptedSampleInfoEntry is defined as a bit mask, with most significant bit first, of the following flags:
NonDecodingParameterSetCorruptedFlag (value 0x00000001): indicates that one or more parameter sets (DCI, VPS, SPS, PPS, APS, OPI?) parameter-set-like NAL units in the associated data is-that are needed for decoding the bitstream are corrupted.
DecodingParameterSetCorruptedFlag (value 0x00000002): indicates that one or more parameter-set-like NAL units in the associated data that are not needed for decoding the bitstream are corrupted.
SEIConfSeiCorruptedFlag (value 0x00000002 0x00000004): indicates that one or more SEI messages NAL units in the associated data is that contain SEI messages affecting the HRD conformance of the bitstream are corrupted.
EsntSeiCorruptedFlag (value 0x00000008): indicates that one or more SEI NAL units in the associated data that contain essential SEI messages not affecting the HRD conformance of the bitstream are corrupted.
NesnSeiCorruptedFlag (value 0x00000010): indicates that one or more SEI NAL units in the associated data that contain non-essential SEI messages not affecting the HRD conformance of the bitstream are corrupted.
Slice VclHeaderCorruptedFlag (value 0x000000004 0x00000020): indicates that one or more NAL unit headers, slice headers or picture headers of the VCL NAL units in the associated data is are corrupted.
VCLVclDataCorruptedFlag (value 0x00000008 0x00000040): indicates that VCL data of one or more slices in the associated data is corrupted, where VCL data refers to data in a VCL NAL unit excluding the NAL unit header, the slice header, and the picture header, if any.
OtherNonVCLNALVclNalCorruptedFlag (value 0x00000010 0x00000080): indicates that one or more non-VCL NAL units in the associated data with types different from the above types is that are not parameter-set-like NAL units and are not SEI NAL units are corrupted.
RefPicCorruptedFlag (value 0x00000100): indicates that one or more of the reference pictures of the slices in the associated data are corrupted.
RefDecParamSetCorruptedFlag (value 0x00000200): indicates that one or more of the parameter-set-like NAL units needed for decoding the slices in the associated data are corrupted.

A codec_specific_param with value 0 means no information is available for describing the corruption.

A CorruptedSampleInfoEntry may be used with a sample group of grouping_type ‘nalm’ and a NALUMapEntry, using the grouping_type_parameter ‘corr’. The groupID of the NALUMapEntry map entry indicates the index, starting from 1, in the sample group description of the CorruptedSampleInfoEntry. A groupID of 0 indicates that no entry is associated (the identified data is present and not corrupted).

### 6. REFERENCES

[1] ITU-T and ISO/IEC, “High efficiency video coding”, Rec. ITU-T H.265|ISO/IEC 23008-2 (in force edition).
[2] J. Chen, E. Alshina, G. J. Sullivan, J.-R. Ohm, J. Boyce, “Algorithm description of Joint Exploration Test Model 7 (JEM7),” JVET-G1001, August 2017.
[3] Rec. ITU-T H.266|ISO/IEC 23090-3, “Versatile Video Coding”.
[4] Rec. ITU-T Rec. H.274|ISO/IEC 23002-7, “Versatile Supplemental Enhancement Information Messages for Coded Video Bitstreams”.
[5] ISO/IEC 14496-12: “Information technology—Coding of audio-visual objects—Part 12: ISO base media file format”.
[6] ISO/IEC 23009-1: “Information technology—Dynamic adaptive streaming over HTTP (DASH)—Part 1: Media presentation description and segment formats”.
[7] ISO/IEC 14496-15: “Information technology—Coding of audio-visual objects—Part 15: Carriage of network abstraction layer (NAL) unit structured video in the ISO base media file format”.
[8] ISO/IEC 23008-12: “Information technology—High efficiency coding and media delivery in heterogeneous environments—Part 12: Image File Format”.
[9] MPEG WG 03 output document N0598, “Technologies under Consideration for ISO/IEC 14496-12”, July 2022.

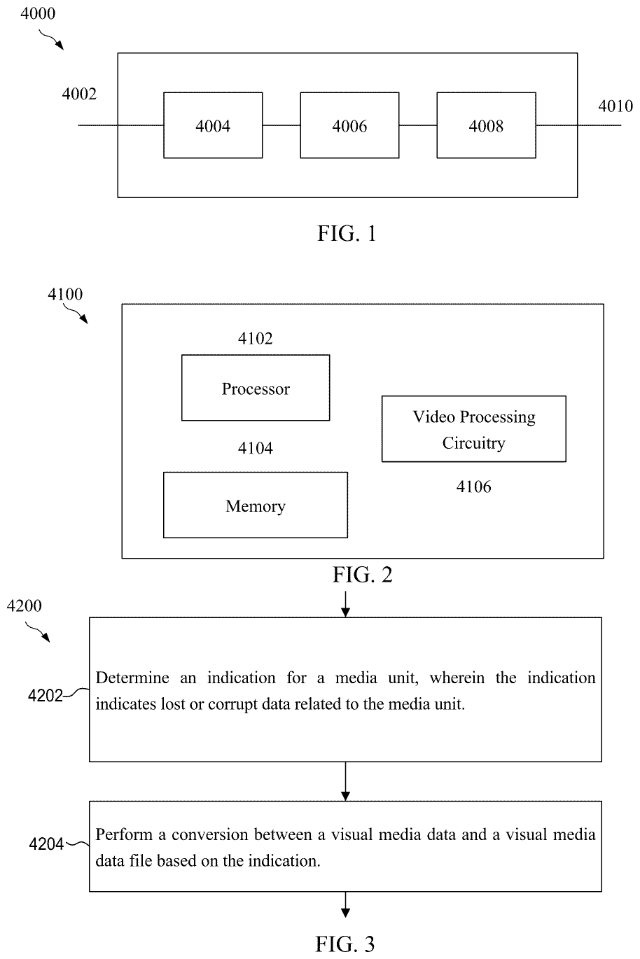

FIG. 1 is a block diagram showing an example video processing system 4000 in which various embodiments disclosed herein may be implemented. Various implementations may include some or all of the components of the system 4000. The system 4000 may include input 4002 for receiving video content. The video content may be received in a raw or uncompressed format, e.g., 8- or 10-bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as Wi-Fi or cellular interfaces.

The system 4000 may include a coding component 4004 that may implement the various coding or encoding methods described in the present disclosure. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or DisplayPort, and so on. Examples of storage interfaces include serial advanced technology attachment (SATA), peripheral component interconnect (PCI), integrated drive electronics (IDE) interface, and the like. The embodiments described in the present disclosure may be embodied in various electronic devices such as mobile phones, laptops, smartphones or other devices that are capable of performing digital data processing and/or video display.

FIG. 2 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present disclosure. The memory (memories) 4104 may be used for storing data and code used for implementing the methods and embodiments described herein. The video processing circuitry 4106 may be used to implement, in hardware circuitry, some embodiments described in the present disclosure. In some embodiments, the video processing circuitry 4106 may be at least partly included in the processor 4102, e.g., a graphics co-processor.

FIG. 3 is a flowchart for an example method 4200 of video processing. The method 4200 determines an indication for a media unit, wherein the indication indicates lost or corrupt data related to the media unit at step 4202. A conversion is performed between a visual media data and a visual media data file based on the indication at step 4204.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

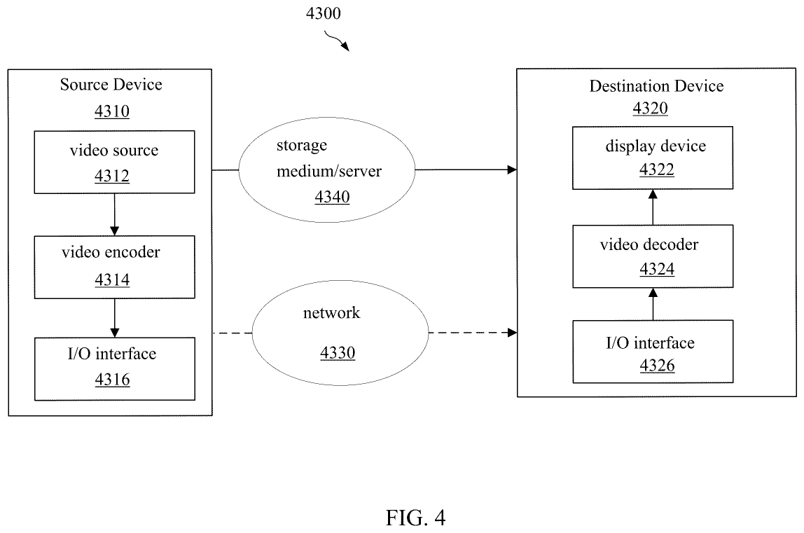

FIG. 4 is a block diagram that illustrates an example video coding system 4300 that may utilize the embodiments of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVC) standard and other current and/or further standards.

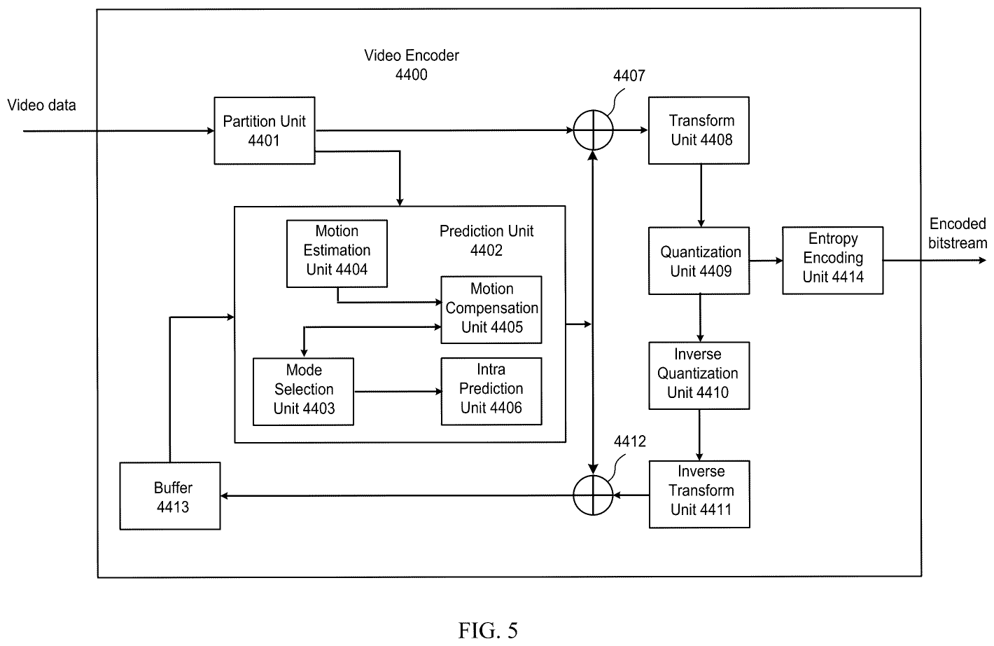

FIG. 5 is a block diagram illustrating an example of video encoder 4400, which may be video encoder 4314 in the system 4300 illustrated in FIG. 4. Video encoder 4400 may be configured to perform any or all of the embodiments of this disclosure. The video encoder 4400 includes a plurality of functional components. The embodiments described in this disclosure may be shared among the various components of video encoder 4400. In some examples, a processor may be configured to perform any or all of the embodiments described in this disclosure.

The functional components of video encoder 4400 may include a partition unit 4401; a prediction unit 4402, which may include a mode select unit 4403, a motion estimation unit 4404, a motion compensation unit 4405, and an intra prediction unit 4406; a residual generation unit 4407; a transform processing unit 4408; a quantization unit 4409; an inverse quantization unit 4410; an inverse transform unit 4411; a reconstruction unit 4412; a buffer 4413; and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

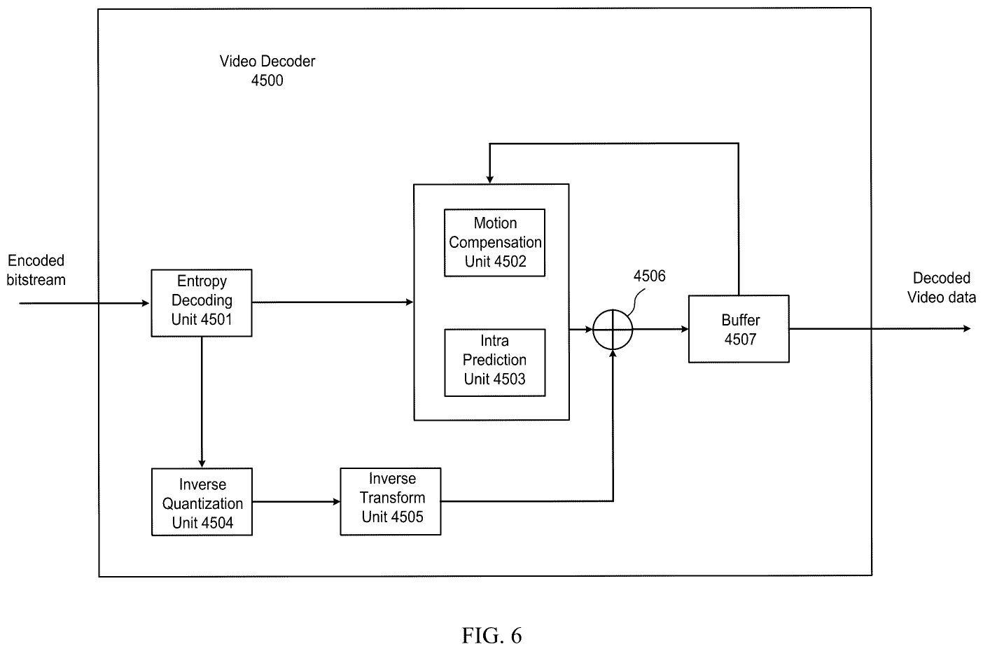

FIG. 6 is a block diagram illustrating an example of video decoder 4500 which may be video decoder 4324 in the system 4300 illustrated in FIG. 4. The video decoder 4500 may be configured to perform any or all of the embodiments of this disclosure. In the example shown, the video decoder 4500 includes a plurality of functional components. The embodiments described in this disclosure may be shared among the various components of the video decoder 4500. In some examples, a processor may be configured to perform any or all of the embodiments described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

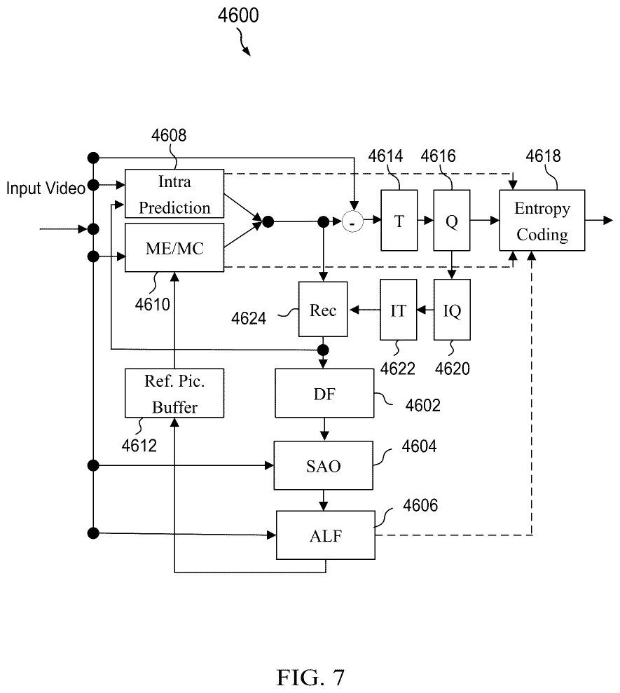

FIG. 7 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

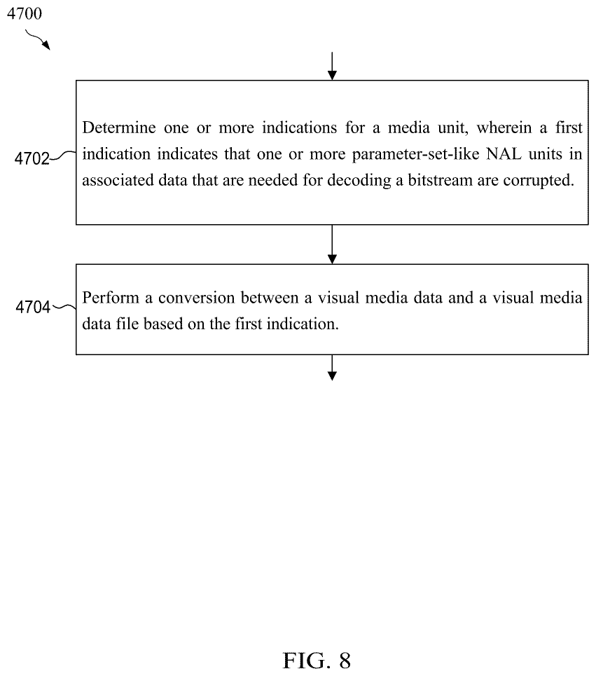

FIG. 8 is a flowchart for an example method 4700 of video processing. The method 4700 includes determining one or more indications for a media unit at step 4702. A first indication indicates that one or more parameter-set-like network abstraction layer (NAL) units in associated data that are needed for decoding a bitstream are corrupted. A conversion is performed between a visual media data and a bitstream based on the first indication at step 4704.

It should be noted that the method 4700 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4700 can be performed by a non-transitory computer readable medium comprising a computer program product for use by a video coding device. The computer program product comprises computer executable instructions stored on the non-transitory computer readable medium such that when executed by a processor cause the video coding device to perform the method 4700.

A listing of solutions preferred by some examples is provided next.

The following solutions show examples of embodiments discussed herein.

1. A method for processing media data comprising: determining an indication for a media unit, wherein the indication indicates lost or corrupt data related to the media unit; and performing a conversion between a visual media data and a visual media data file based on the indication.

2. The method of solution 1, wherein the indication indicates one or more of parameter-set-like network abstraction layer (NAL) units in the media unit that are needed for decoding the bitstream are corrupted.

3. The method of any of solutions 1-2, wherein the indication indicates one or more of parameter-set-like NAL units in the media unit that are not needed for decoding the bitstream are corrupted.

4. The method of any of solutions 1-3, wherein the indication indicates one or more supplemental enhancement information (SEI) NAL units in the media unit that contain SEI messages affecting the hypothetical reference decoder (HRD) conformance are corrupted.

5. The method of any of solutions 1-4, wherein the indication indicates one or more SEI NAL units in the media unit that contain essential SEI messages not affecting HRD conformance are corrupted.

6. The method of any of solutions 1-5, wherein the indication indicates one or more SEI NAL units in the media unit that contain non-essential SEI messages not affecting HRD conformance are corrupted.

7. The method of any of solutions 1-6, wherein the indication indicates one or more SEI NAL units in the media unit that contain essential SEI messages are corrupted.

8. The method of any of solutions 1-7, wherein the indication indicates one or more SEI NAL units in the media unit that contain non-essential SEI messages are corrupted.

9. The method of any of solutions 1-8, wherein the indication indicates one or more NAL unit headers, slice headers, or picture headers in the media unit are corrupted.

10. The method of any of solutions 1-9, wherein the indication indicates one or more NAL unit headers in the media unit are corrupted.

11. The method of any of solutions 1-10, wherein the indication indicates one or more slice headers in the media unit are corrupted.

12. The method of any of solutions 1-11, wherein the indication indicates one or more picture headers in the media unit are corrupted.

13. The method of any of solutions 1-12, wherein the indication indicates video coding layer (VCL) data of one or more slices in the media unit are corrupted, and wherein VCL data includes data in a VCL NAL unit excluding a NAL unit header, a slice header, and a picture header.

14. The method of any of solutions 1-13, wherein the indication indicates one or more reference pictures of slices in the media unit are corrupted.

15. The method of any of solutions 1-14, wherein the indication indicates one or more parameter-set-like NAL units needed for decoding slices in the media unit are corrupted.

16. The method of any of solutions 1-15, wherein the indication indicates referenced data of one or more reference pictures used by slices in the media unit are corrupted.

17. The method of any of solutions 1-16, wherein the indication indicates one or more of reference pictures of slices in the media unit are corrupted or lost.

18. The method of any of solutions 1-17, wherein the indication indicates referenced data of one or more reference pictures used by slices in the media unit are corrupted or lost.

19. The method of any of solutions 1-18, wherein the indication indicates one or more reference pictures of slices in the media unit are lost.

20. The method of any of solutions 1-19, wherein the indication indicates referenced data of one or more reference pictures used by slices in the media unit are lost.

21. The method of any of solutions 1-20, wherein the indication indicates one or more parameter-set-like NAL units needed for decoding the media unit are corrupted or lost.

22. The method of any of solutions 1-21, wherein the indication indicates one or more parameter-set-like NAL units needed for decoding the media unit are lost.

23. The method of any of solutions 1-22, wherein the indication indicates one or more slices in the media unit are lost.

24. The method of any of solutions 1-23, wherein the indication indicates one or more parameter-set-like NAL units in the media unit are lost.

25. The method of any of solutions 1-24, wherein the indication indicates one or more slices in the media unit are corrupted or lost.

26. The method of any of solutions 1-25, wherein the indication indicates one or more parameter-set-like NAL units in the media unit are corrupted or lost.

27. An apparatus for processing video data comprising: a processor; and a non-transitory memory with instructions thereon, wherein the instructions upon execution by the processor, cause the processor to perform the method of any of solutions 1-26.

28. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-26.

29. A non-transitory computer-readable recording medium storing a bitstream of a video which is generated by a method performed by a video processing apparatus, wherein the method comprises: determining an indication for a media unit, wherein the indication indicates lost or corrupt data related to the media unit; and generating a bitstream based on the determining.

30. A method for storing bitstream of a video comprising: determining an indication for a media unit, wherein the indication indicates lost or corrupt data related to the media unit; generating a bitstream based on the determining; and storing the bitstream in a non-transitory computer-readable recording medium.

31. A method, apparatus, or system described in the present disclosure.

The following solutions show further examples of embodiments discussed herein.

1. A method for processing media data comprising: determining one or more indications for a media unit, wherein a first indication indicates that one or more parameter-set-like network abstraction layer (NAL) units in associated data that are needed for decoding a bitstream are corrupted; and performing a conversion between a visual media data and a visual media data file based on the first indication.

2. The method of solution 1, wherein the first indication is a Decoding Parameter Set Corrupted Flag (DecodingParameterSetCorruptedFlag) with a value of 0x00000001.

3. The method of any of solutions 1-2, wherein a second indication indicates that one or more parameter-set-like NAL units in the associated data that are not needed for decoding the bitstream are corrupted.

4. The method of solution 3, wherein the second indication is a Non-Decoding Parameter Set Corrupted Flag (NonDecodingParameterSetCorruptedFlag) with a value of 0x00000002.

5. The method of any of solutions 1-4, wherein a third indication indicates that one or more supplemental enhancement information (SEI) NAL units in the associated data that contain SEI messages affecting hypothetical reference decoder (HRD) conformance of the bitstream are corrupted.

6. The method of solution 5, wherein the third indication is a Conformance SEI Corrupted Flag (ConformanceSeiCorruptedFlag) with a value of 0x00000004.

7. The method of any of solutions 1-6, wherein a fourth indication indicates that one or more SEI NAL units in the associated data that contain essential SEI messages not affecting HRD conformance of the bitstream are corrupted.

8. The method of solution 7, wherein the fourth indication is an essential SEI corrupted flag (EssentialSeiCorruptedFlag) with a value of 0x00000008.

9. The method of any of solutions 1-8, wherein a fifth indication indicates that one or more SEI NAL units in the associated data that contain non-essential SEI messages not affecting HRD conformance of the bitstream are corrupted.

10. The method of solution 9, wherein the sixth indication is a nonessential SEI corrupted flag (NonessentialSeiCorruptedFlag) with a value of 0x00000010.

11. The method of any of solutions 1-10, wherein a sixth indication indicates that one or more NAL unit headers, slice headers, or picture headers of video coding layer (VCL) NAL units in the associated data are corrupted.

12. The method of solution 11, wherein the sixth indication is a VCL header corrupted flag (VclHeaderCorruptedFlag) with a value of 0x00000020.

13. The method of any of solutions 1-12, wherein a seventh indication indicates that VCL data of one or more slices in the associated data is corrupted, and wherein VCL data refers to data in a VCL NAL unit excluding a NAL unit header, a slice header, and a picture header.

14. The method of solution 13, wherein the seventh indication is a VCL data corrupted flag (VclDataCorruptedFlag) with a value of 0x00000040.

15. The method of any of solutions 1-14, wherein an eighth indication indicates that one or more reference pictures of slices in the associated data are corrupted.

16. The method of solution 15, wherein the eighth indication is a reference picture corrupted flag (RefPicCorruptedFlag) with a value of 0x00000100.

17. The method of any of solutions 1-16, wherein a ninth indication indicates that one or more parameter-set-like NAL units needed for decoding slices in the associated data are corrupted.

18. The method of solution 17, wherein the ninth indication is a reference picture decoding parameter set corrupted flag (RefDecParamSetCorruptedFlag) with a value of 0x00000200.

19. The method of any of solutions 1-18, wherein at least one indication indicates one or more SEI NAL units in the media unit that contain essential SEI messages are corrupted.

20. The method of any of solutions 1-19, wherein at least one indication indicates one or more SEI NAL units in the media unit that contain non-essential SEI messages are corrupted.

21. The method of any of solutions 1-20, wherein at least one indication indicates one or more NAL unit headers in the media unit are corrupted.

22. The method of any of solutions 1-21, wherein at least one indication indicates one or more slice headers in the media unit are corrupted.

23. The method of any of solutions 1-22, wherein at least one indication indicates one or more picture headers in the media unit are corrupted.

24. The method of any of solutions 1-23, wherein at least one indication indicates referenced data of one or more reference pictures used by slices in the media unit are corrupted.

25. The method of any of solutions 1-24, wherein at least one indication indicates one or more of reference pictures of slices in the media unit are corrupted or lost.

26. The method of any of solutions 1-25, wherein at least one indication indicates referenced data of one or more reference pictures used by slices in the media unit are corrupted or lost.

27. The method of any of solutions 1-26, wherein at least one indication indicates one or more reference pictures of slices in the media unit are lost.

28. The method of any of solutions 1-27, wherein at least one indication indicates referenced data of one or more reference pictures used by slices in the media unit are lost.

29. The method of any of solutions 1-28, wherein at least one indication indicates one or more parameter-set-like NAL units needed for decoding the media unit are corrupted or lost.

30. The method of any of solutions 1-29, wherein at least one indication indicates one or more parameter-set-like NAL units needed for decoding the media unit are lost.

31. The method of any of solutions 1-30, wherein at least one indication indicates one or more slices in the media unit are lost.

32. The method of any of solutions 1-31, wherein at least one indication indicates one or more parameter-set-like NAL units in the media unit are lost.

33. The method of any of solutions 1-32, wherein at least one indication indicates one or more slices in the media unit are corrupted or lost.

34. The method of any of solutions 1-33, wherein at least one indication indicates one or more parameter-set-like NAL units in the media unit are corrupted or lost.

35. The method of any of solutions 1-34, wherein the conversion includes encoding the visual media data into the visual media data file.

36. The method of any of solutions 1-34, wherein the conversion includes decoding the visual media data from the visual media data file.

37. An apparatus for processing video data comprising: a processor; and a non-transitory memory with instructions thereon, wherein the instructions upon execution by the processor, cause the processor to perform the method of any of solutions 1-36.

38. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-36.

39. A non-transitory computer-readable recording medium storing a bitstream of a video which is generated by a method performed by a video processing apparatus, wherein the method comprises: determining one or more indications for a media unit, wherein a first indication indicates that one or more parameter-set-like network abstraction layer (NAL) units in associated data that are needed for decoding a bitstream are corrupted; and generating a bitstream based on the determining.

40. A method for storing bitstream of a video comprising: determining one or more indications for a media unit, wherein a first indication indicates that one or more parameter-set-like network abstraction layer (NAL) units in associated data that are needed for decoding a bitstream are corrupted; generating a bitstream based on the determining; and storing the bitstream in a non-transitory computer-readable recording medium.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present disclosure, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this disclosure can be implemented in digital electronic circuitry, or in computer software, firmware, or hardware, including the structures disclosed in this disclosure and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., a field-programmable gate array (FPGA) or an application-specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While the present disclosure contains many specifics, these should not be construed as limitations on the scope of any subject matter or of what may be claimed, but rather as descriptions of features that may be specific to particular embodiments of the present disclosure. Certain features that are described in the present disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

Only a few implementations and examples are described and other implementations, enhancements and variations can be made based on what is described and illustrated in the present disclosure.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for processing media data, comprising:
determining one or more indications for a media unit, wherein the one or more indications comprise a first indication indicating that one or more parameter-set-like network abstraction layer (NAL) units in associated data that are needed for decoding a bitstream are corrupted; and
performing a conversion between media data and a media data file based on the first indication.

2. The method of claim 1, wherein the first indication is a first parameter set corrupted flag with a value of 0x00000001.

3. The method of claim 1, wherein the one or more indications comprise a second indication indicating that one or more parameter-set-like NAL units in the associated data that are not needed for decoding the bitstream are corrupted, and
wherein the second indication is a second parameter set corrupted flag with a value of 0x00000002.

4. The method of claim 1, wherein the one or more indications comprise a third indication indicating that one or more supplemental enhancement information (SEI) NAL units in the associated data that contain SEI messages affecting hypothetical reference decoder (HRD) conformance of the bitstream are corrupted, and
wherein the third indication is a conformance SEI corrupted flag with a value of 0x00000004.

5. The method of claim 1, wherein the one or more indications comprise a fourth indication indicating that one or more supplemental enhancement information (SEI) NAL units in the associated data that contain essential SEI messages not affecting hypothetical reference decoder (HRD) conformance of the bitstream are corrupted, and
wherein the fourth indication is an essential SEI corrupted flag with a value of 0x00000008.

6. The method of claim 1, wherein the one or more indications comprise a fifth indication indicating that one or more supplemental enhancement information (SEI) NAL units in the associated data that contain non-essential SEI messages not affecting hypothetical reference decoder (HRD) conformance of the bitstream are corrupted, and
wherein the fifth indication is a non-essential SEI corrupted flag with a value of 0x00000010.

7. The method of claim 1, wherein the one or more indications comprise a sixth indication indicating that one or more NAL unit headers, slice headers, or picture headers of video coding layer (VCL) NAL units in the associated data are corrupted, and
wherein the sixth indication is a VCL header corrupted flag with a value of 0x00000020.

8. The method of claim 1, wherein the one or more indications comprise a seventh indication indicating that video coding layer (VCL) data of one or more slices in the associated data is corrupted, and
wherein the VCL data refers to data in a VCL NAL unit excluding a NAL unit header, a slice header, and a picture header, if any.

9. The method of claim 8, wherein the seventh indication is a VCL data corrupted flag with a value of 0x00000040.

10. The method of claim 1, wherein the one or more indications comprise an eighth indication indicating that one or more reference pictures of slices in the associated data are corrupted, and
wherein the eighth indication is a reference picture corrupted flag with a value of 0x00000100.

11. The method of claim 1, wherein the one or more indications comprise a ninth indication indicating that one or more parameter-set-like NAL units needed for decoding slices in the associated data are corrupted, and
wherein the ninth indication is a reference picture decoding parameter set corrupted flag with a value of 0x00000200.

12. The method of claim 1, wherein the one or more indications comprise a tenth indication indicating that one or more non-video coding layer (VCL) NAL units in the associated data that are not parameter-set-like NAL units and are not supplemental enhancement information (SEI) NAL units are corrupted, and
wherein the tenth indication is a non-VCL NAL corrupted flag with a value of 0x00000080.

13. The method of claim 1, wherein the one or more parameter-set-like NAL units refer to parameter set NAL units, decoding capability information (DCI) NAL unit, and operating point information (OPI) NAL units collectively.

14. The method of claim 1, further comprising:
determining a codec specific parameter field of a corrupted sample information entry, wherein the codec specific parameter field indicates codec specific information on corruption.

15. The method of claim 14, wherein the codec specific parameter field with value 0 indicates that no information is available for describing the corruption.

16. The method of claim 1, wherein the conversion includes generating the media data file from the media data.

17. The method of claim 1, wherein the conversion includes parsing the media data from the media data file.

18. An apparatus for processing media data comprising: a processor; and a non-transitory memory with instructions thereon, wherein the instructions upon execution by the processor, cause the processor to:
determine one or more indications for a media unit, wherein the one or more indications comprise a first indication indicating that one or more parameter-set-like network abstraction layer (NAL) units in associated data that are needed for decoding a bitstream are corrupted; and
perform a conversion between media data and a media data file based on the first indication.

19. A non-transitory computer-readable storage medium storing instructions that cause a processor to:
determine one or more indications for a media unit, wherein the one or more indications comprise a first indication indicating that one or more parameter-set-like network abstraction layer (NAL) units in associated data that are needed for decoding a bitstream are corrupted; and
perform a conversion between media data and a media data file based on the first indication.

20. A non-transitory computer-readable recording medium storing a media data file of a video which is generated by a method performed by a video processing apparatus, wherein the method comprises:
determining one or more indications for a media unit, wherein the one or more indications comprise a first indication indicating that one or more parameter-set-like network abstraction layer (NAL) units in associated data that are needed for decoding a bitstream are corrupted; and
generating the media data file based on the first indication.
